(19) United States
(12) Patent Application Publication
(10) Pub. No.: US 2008/0309584 A1
(43) Pub. Date: Dec. 18, 2008

(54) VIDEO EXTENDER DEVICES CAPABLE OF PROVIDING EDID OF A DISPLAY TO A COMPUTER

(75) Inventor: Wen Zhang, Richmond (CA)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Taipei (TW)

(21) Appl. No.: 12/021,427

(22) Filed: Jan. 29, 2008

Related U.S. Application Data
(60) Provisional application No. 60/943,554, filed on Jun. 12, 2007.

(51) Int. Cl. G09G 5/00

(52) U.S. Cl. 345/5

(57) ABSTRACT

In a KVM switch system in which one or more consoles and one or more computers are connected to a KVM switch via dongles (console dongles and computer dongles, respectively), a method is provided for transferring the extended display identification data (EDID) of a display of a console to a computer. When the console is booted, the corresponding console dongle queries the display to obtain its EDID, and transmits it to the computer dongle via the KVM switch. The computer dongle stores the received EDID in its memory. The computer dongle also stores a default EDID in its memory. When the computer queries EDID, the computer dongle provides either the received EDID to the computer, or provide the default EDID if no EDID has been received from the KVM switch.

This application claims priority from U.S. Provisional Patent Application No. 60/943,554, filed Jun. 12, 2007, which is herein incorporated by reference in its entirety.

This application is related to commonly owned U.S. patent application Ser. No. 11/675,238, filed Feb. 15, 2007, which is herein incorporated by reference in its entirety.

### BACKGROUND OF THE INVENTION

1. Field of the Invention

This invention relates to video extender devices, and in particular, it relates to video extender devices for connecting a computer to a console via a KVM switch and related methods. The video extender devices are capable of providing EDID of a display to a computer.

2. Description of the Related Art

Conventionally, a display device for a personal computer is directly connected to the computer. When the computer is powered on, it queries extended display identification data (EDID) of the display through a Display Data Channel (DDC) circuit between the display and the computer. EDID is a data structure provided by a computer display to describe its capabilities to the computer. To ensure that the display setting of the computer and specification of the display correspond with each other and to enable the best video quality to be displayed on the display, it is necessary for the computer to obtain the EDID queried from the display.

A KVM (keyboard video mouse) switch is a device that allows one or more user consoles (each including a keyboard and/or mouse and a display device) to communicate with selected ones of a plurality of computers connected to the KVM switch. The KVM switch includes one or more switching elements that selectively transmit the keyboard and mouse signals, video signals, and other signals between each console and a selected computer. When a console device, including a display, a keyboard and/or a mouse, is connected to a plurality of computers via a KVM (keyboard, video, mouse) switch, a user of the KVM switch may switch to one of the computers connected thereto to remotely communicate with the computer and monitor the video image from the computer on the display of the console. However, conventionally, the computer cannot query the EDID of the display of the console due to the KVM switch connected in between. According to some existing methods, a KVM switch may pre-stores default EDID, and when the computer is powered on and queries EDID, the KVM switch disregards the actual specification of the display but only provides the default EDID to the computer. Furthermore, some KVM switches (especially low-end products) may not have a memory for pre-storing default EDID. Accordingly, the computers coupled to such KVM switches can only use the default EDID stored in the computer. The default EDID provided by the KVM switch or stored in the computer may be different from the actual EDID of the display, and may cause problems such as resolution mismatch, resulting in inferior image display.

### SUMMARY OF THE INVENTION

Accordingly, the present invention is directed to a method and apparatus for providing the EDID of a display device to a computer that substantially obviates one or more of the problems due to limitations and disadvantages of the related art.

An object of the present invention is to allow a computer connected to a KVM switch or a console via a dongle to receive the actual EDID of the display.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides an extender device which includes: a first communication port for connecting to a display device; a second communication port adapted for connecting to an external device; and a control section connected to the first and second communication ports, wherein the control section queries the display device for its extended display identification data (EDID) and transmits the EDID to the external device.

In another aspect, the present invention provides an extender device which includes: a first communication port for connecting to a computer; a second communication port adapted for connecting to an external device; and a control section connected to the first and second communication ports, wherein the control section stores a extended display identification data (EDID) when it is received from the external device, and provides the stored EDID to the computer when the computer queries the extender for an EDID.

In another aspect, the present invention provides a data processing system which includes: a KVM (keyboard video mouse) switch; one or more consoles each including a display device; one or more first extender devices each for connecting a console to the KVM switch; one or more computers; and one or more second extender devices each for connecting a computer to the KVM switch, wherein each first extender device queries the corresponding display device for its extended display identification data (EDID) and transmits the EDID to the KVM switch, wherein the KVM switch transmits the EDID from each first extender devices to one or more second extender devices, wherein each second extender device stores the EDID when it is received from the KVM switch and provides the stored EDID to the corresponding computer when the computer queries the second extender for an EDID.

In another aspect, the present invention provides a data processing system which includes: a console including a display device; a first extender device connected to the console; a computer; and a second extender device connected to the computer, wherein the first extender device queries the display device for its extended display identification data (EDID) and transmits the EDID to the second extender device, wherein the second extender device stores the EDID when it is received from the first extender device and provides the stored EDID to the computer when the computer queries the second extender for an EDID.

In yet another aspect, the present invention provides a method for communicating extended display identification data (EDID) of a display device to a computer, which includes: a first extender device connected to the display device querying the display device for its EDID; the first extender device transmits the EDID to a second extender device connected to the first extender device; the second extender device stores the EDID received from the first extender device; the second extender device providing the stored EDID to the computer when the computer queries the second extender for EDID.

It is to be understood that both the foregoing general description and the following detailed description are exemplary and explanatory and are intended to provide further explanation of the invention as claimed.

### BRIEF DESCRIPTION OF THE DRAWINGS

FIG. 1A illustrates a system including a display connected to a computer via a console dongle, a KVM switch and a computer dongle in which embodiments of the present invention may be implemented.

FIG. 1B illustrates a system including a display connected to a computer via a KVM switch and a computer dongle in which embodiments of the present invention may be implemented.

FIGS. 1C and 1D illustrate systems including a display connected to a computer via a console dongle and a computer dongle in which embodiments of the present invention may be implemented.

FIGS. 2A and 2B illustrate a console dongle and a computer dongle, respectively.

FIG. 3 illustrates a method performed by the console dongle according to an embodiment of the present invention.

FIG. 4 illustrates a method performed by the computer dongle according to an embodiment of the present invention.

FIG. 5 illustrates a system in which a display is connected to a plurality of computers via a KVM switch.

### DETAILED DESCRIPTION OF THE PREFERRED EMBODIMENTS

Commonly owned U.S. patent application Ser. No. 11/675,238, filed Feb. 15, 2007 describes a KVM switch that provides actual EDID from a display device of a console to computers coupled to the KVM switch. In a system described therein, both the display and the computers are directly connected to the KVM switch, such as by VGA cables (see FIG. 5). The KVM switch comprises a processor, at least one memory and at least one switch. The processor queries EDID of the actual display after the KVM switch is booted, and stores the EDID in the memory as the first EDID. When a computer queries EDID, e.g. during booting of the computer, the KVM switch either couples the computer to the display so that the display will provide its EDID to the computer, or couples the computer to the memory to provide the first EDID stored therein to the computer. When the first EDID is available from the memory, the switch couples the computer to the memory. When the first EDID is not available from the memory, the switch couples the computer to the display. As a result, the computer is able to obtain the EDID of the display, and can display video from the computer on the display using the correct settings such as resolution. The memory may further store a default EDID as the second EDID. When a computer queries EDID, if the first EDID is not available from the memory and the display is not available to provide the EDID, the KVM switch provides the second EDID stored in the memory to the computer.

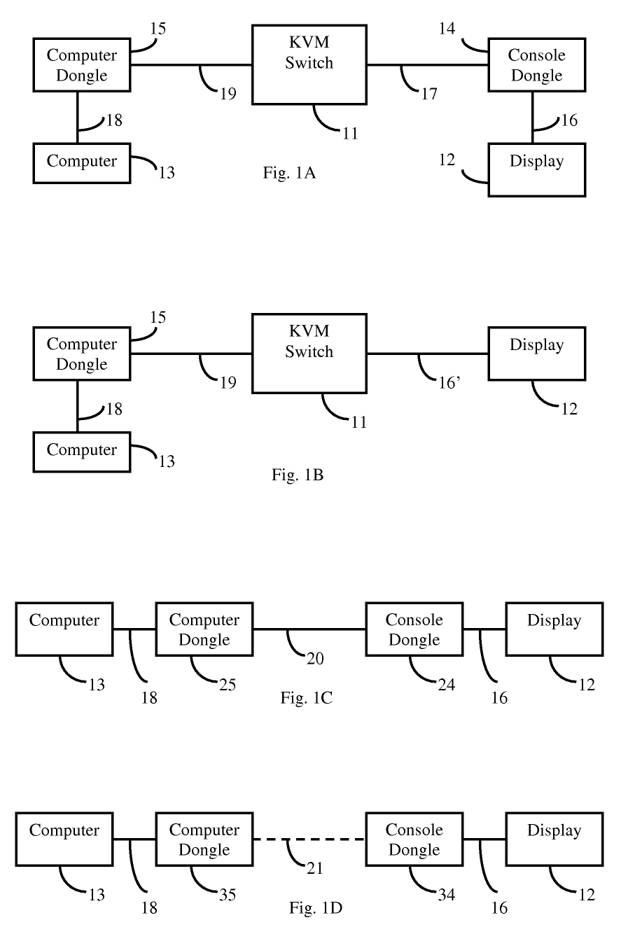

The present invention extends the above method of providing EDID of the display to the computer to systems in which either the computer or the display or both are connected to a KVM switch by a dongle, as shown in FIGS. 1A and 1B, and to systems in which a computer and a console located remotely from each other are connected via dongles without a KVM switch, as shown in FIGS. 1C and 1D.

FIG. 1A illustrates a system that includes a KVM switch 11, a display 12 (which is a part of a console including a display and a keyboard and/or a mouse, but the keyboard and the mouse are not shown), and a computer 13. The display 12 is connected to the KVM switch 11 via a console dongle 14 and the computer 13 is connected to the KVM switch 11 via a computer dongle 15. Two or more computers and/or two or more displays may be connected to the KVM switch (each via its own dongle), although only one of each is shown in FIG. 1A to avoid overcrowding. FIG. 1B illustrates a system similar to that in FIG. 1A except that the display 12 is connected to the KVM switch 11 without a dongle. The KVM switch 11 may also be an Internet-enabled KVM switch where the consoles and/or the computers are connected to the KVM switch via the Internet, or wireless KVM switch where the consoles and/or the computers are connected to the KVM switch via wireless communication channels. In one embodiment, the KVM switch 11 in FIGS. 1A and 1B may be a matrix KVM. The display 12 in FIG. 1B may be a local console when the KVM switch 11 is a matrix KVM.

In the systems shown in FIGS. 1A and 1B, the computer dongle 15 is typically connected to the KVM switch 11 via a cable 19 that is capable of transmitting signals over a relatively long distance (up to hundreds of feet), such as a CAT5 (Category 5) cable. Thus, the computer dongle 15 has a corresponding connector into which a connector of the cable 19 is plugged in. The connection 18 between the computer dongle 15 and the computer 13 is typically a short cable (a few feet long), and can be either physically a part of the computer dongle, or physically separate cables. In one particular example, the computer dongle has a housing that houses electrical circuits, a connector on the housing for receiving a CAT5 cable, and two or more short cables extending from the housing with suitable connectors at their ends for plugging into a computer. In another particular example, the computer dongle has a housing that houses electrical circuits, a connector on the housing for receiving a CAT5 cable, and two or more connectors on the housing for receiving cables from the computer 13. Similarly, the console dongle 14 is typically connected to the KVM switch 11 via a cable 17 that is capable of transmitting signals over a relatively long distance, such as a CAT5 cable. Thus, the console dongle 14 has a corresponding connector into which a connector of the cable 17 is plugged in. The connection 16 between the console dongle 14 and the display 12 is typically a short cable (a few feet long), and can be either physically a part of the console dongle, or physically separate cables. In one particular example, the console dongle has a housing that houses electrical circuits, a connector on the housing for receiving a CAT5 cable, and two or more connectors on the housing for receiving cables from the console including the display. In another particular example, the console dongle has a housing that houses electrical circuits, a connector on the housing for receiving a CAT5 cable, and two or more short cables extending from the housing with suitable connectors at their ends for plugging into a display and a keyboard and/or mouse. In the system shown in FIG. 1B where no console dongle is present, the display 12 is directly connected to the KVM switch 11 by a short cable 16′, or the display may be a built-in part of the KVM switch.

FIG. 1C illustrates a KVM extender system. A computer dongle 25 and a console dongle 24 are directly connected to each other via a wired communication channel 20 that is capable of transmitting signals over a relatively long distance, such as a CAT5 cable. The system illustrated in FIG. 1D is similar to that shown in FIG. 1C, but the computer dongle 35 and the consoled dongle 34 communicate via a wireless communication channel 21.

As used in this disclosure, the term “dongle” should be understood broadly to refer to a device with any suitable physical form factor. The dongles 14, 15, 24, 25, 35 and 35 may alternatively be referred to as “extenders”, “modules” or “adaptors.”

According to embodiments of the present invention, the console dongle 14/24/34, the computer dongle 15/25/35 and the KVM switch 11 (if present) cooperate with each other to provide EDID of the display 12 to the computer 13. In the system of FIG. 1A, when the display 12 is booted, the console dongle 14 queries the display to obtain the EDID of the display. The EDID is provided from the console dongle 14 to the KVM switch 11, from the KVM switch to the computer dongle 15, and from the computer dongle to the computer 13. In the system of FIG. 1B, the KVM switch 11 queries the display 12 to obtain the EDID when the display is booted, and the EDID is provided from the KVM switch to the computer dongle 15, and from the computer dongle to the computer 13. In the system of FIG. 1C, when the display 12 is booted, the console dongle 24 queries the display to obtain the EDID of the display. The EDID is provided from the console dongle 24 to the computer dongle 25 by wired or wireless communication channels, and from the computer dongle to the computer 13. In the system of FIG. 1D, when the display 12 is booted, the console dongle 34 queries the display 12 to obtain the EDID of the display. The EDID is provided from the console dongle 34 to the computer dongle 35 by wireless communication channels, and from the computer dongle to the computer 13.

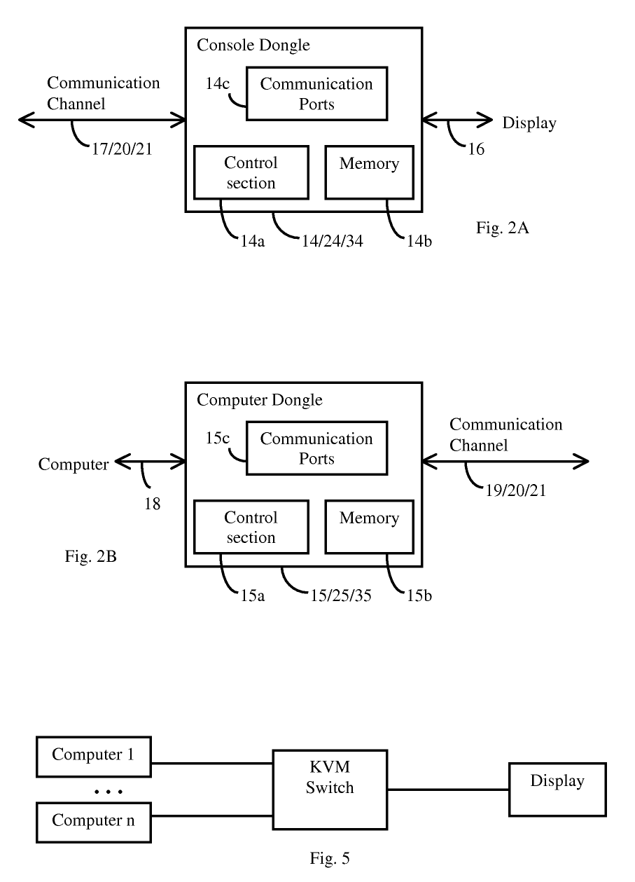

The console dongle, the computer dongle and the KVM switch contain necessary circuitry for carrying out the various method steps to accomplish these tasks. FIG. 2A illustrates the structure of the console dongles 14, 24 and 34, which includes a control section 14a, memory 14b and communication ports 14c for communicating with a display at one end and with a KVM switch or a computer dongle at the other end. As pointed out earlier, the cables connecting the console dongle to the display may be physically a part of the console dongle. In the console dongles 14 and 24, the communication ports 14c may be RS485 ports for a wired communication channel. In the console dongle 34, the communication ports 14c may be wireless communication ports for a wireless communication channel. Similarly, as shown in FIG. 2B, the computer dongles 15, 25 and 35 each includes a control section 15a, memory 15b and communication ports 15c for communicating with a computer at one end and with a KVM switch or a console dongle at the other end. The cables connecting the computer dongle to the computer may be physically a part of the computer dongle. In the computer dongles 15 and 25, the communication ports 15c may be RS485 ports for a wired communication channel. In the computer dongle 35, the communication ports 15c may be wireless communication ports for a wireless communication channel. The control sections 14a and 15a may be implemented by any suitable structure such as processor, ASIC (application-specific IC), FPGA (field-programmable gate array), etc.

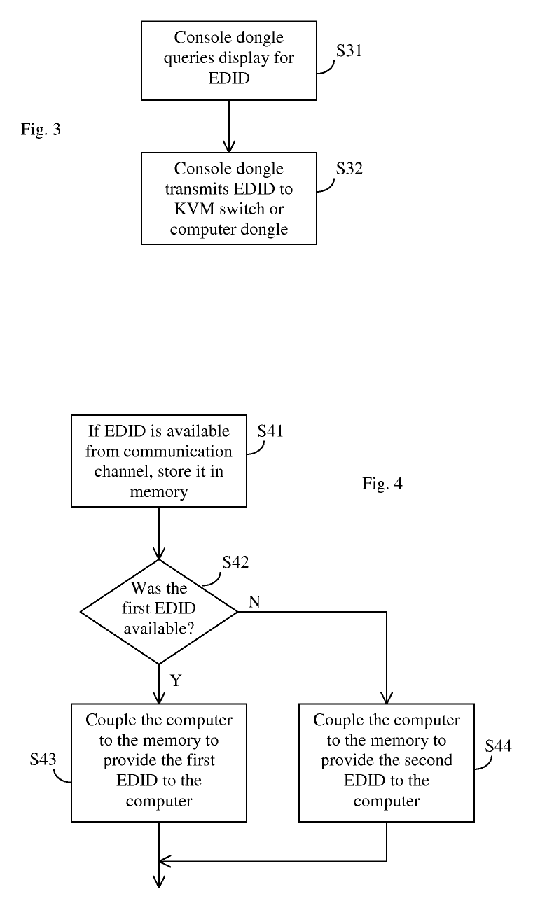

A process performed by the console dongles 14, 24 and 34 is illustrated in FIG. 3. When the console including the display 12 is booted, the console dongle queries the display to obtain the EDID of the display (step S31). Step 31 may also be performed when the console dongle detects that a display is changed, i.e., a different or new display is attached. The console dongle then transmits the EDID to a KVM switch 11 (in the system shown in FIG. 1A) or to a computer dongle 25 or 35 (in the system shown in FIGS. 1C of 1D) (step S32).

When the display is connected to the KVM switch without a console dongle (e.g. in the system of FIG. 1B), the method shown in FIG. 3 is performed by the KVM switch. As described earlier, in the system shown in FIG. 1A, after the console dongle 14 performs step S32, the KVM switch 11 transfers the EDID it received from the console dongle to the computer dongle 15. The KVM switch 11 may choose to also store the EDID in its own memory.

A process performed by the computer dongles 15, 25 and 35 is illustrated in FIG. 4. If the computer dongle receives EDID from the communication channel, either from a KVM switch 11 (in the system of FIG. 1A or 1B) or from a console dongle 24 or 34 (in the system of FIG. 1C or 1D), it stores the received EDID in its memory as the first EDID (step S41). If a first EDID is already stored in the memory, the old first EDID is overwritten. In addition, similar to the KVM switch described in the commonly owned U.S. patent application Ser. No. 11/675,238, the computer dongles 15, 25 and 35 pre-store a default EDID in its memory as the second EDID. When the computer 13 queries EDID, e.g. during booting of the computer, the computer dongle determines whether first EDID was available from the communication channel and was stored in the memory (step S42). If the answer is Yes, the computer dongle provides the first EDID stored in the memory (i.e. the EDID received from the communication channel) to the computer (step S43). If the answer is No, the computer dongle provides the second EDID stored in the memory (i.e. the default EDID) to the computer (step S44).

It will be apparent to those skilled in the art that various modification and variations can be made in the method and apparatus of the present invention without departing from the spirit or scope of the invention. Thus, it is intended that the present invention cover modifications and variations that come within the scope of the appended claims and their equivalents.

What is claimed is:

1. An extender device comprising:
a first communication port adapted for connecting to a display device;
a second communication port adapted for connecting to an external device; and
a control section connected to the first and second communication ports, wherein the control section queries the display device for its extended display identification data (EDID) and transmits the EDID to the external device.

2. The extender device of claim 1, wherein the second communication port is adapted to communicate with the external device via a wired communication channel.

3. The extender device of claim 1, wherein the second communication port is adapted to communicate with the external device via a wireless communication channel.

4. The extender device of claim 1, wherein the external device is a keyboard video mouse (KVM) switch which includes one or more switching elements.

5. The extender device of claim 1, wherein the control section is a processor, an application-specific IC (ASIC), or a field-programmable gate array (FPGA).

6. An extender device comprising:
a first communication port adapted for connecting to a computer;
a second communication port adapted for connecting to an external device; and
a control section connected to the first and second communication ports, wherein the control section stores extended display identification data (EDID) when it is received from the external device, and provides the stored EDID to the computer when the computer queries the extender for EDID.

7. The extender device of claim 6, wherein the control section pre-stores default EDID and provides the default EDID to the computer when the computer queries the extender for EDID but no EDID has been received from the external device.

8. The extender device of claim 6, wherein the second communication port is adapted to communicate with the external device via a wired communication channel.

9. The extender device of claim 6, wherein the second communication port is adapted to communicate with the external device via a wireless communication channel.

10. The extender device of claim 6, wherein the external device is a keyboard video mouse (KVM) switch which includes one or more switching elements.

11. The extender device of claim 6, wherein the control section is a processor, an application-specific IC (ASIC), or a field-programmable gate array (FPGA).

12. A data processing system comprising:
a console including a display device;
a first extender device connected to the console;
a computer; and
a second extender device connected to the computer,
wherein the first extender device queries the display device for its extended display identification data (EDID) and transmits the EDID to the second extender device,
wherein the second extender device stores the EDID when it is received from the first extender device and provides the stored EDID to the computer when the computer queries the second extender for EDID.

13. The data processing system of claim 12, wherein the second extender device pre-stores default EDID and provides the default EDID to the computer when the computer queries the second extender for EDID but no EDID has been received from the first extender device.

14. The data processing system of claim 12, further comprising a keyboard video mouse (KVM) switch which includes one or more switching elements,
wherein the first extender device is connected to the KVM switch and transmits the EDID to the KVM switch, and
wherein the second extender device is connected to the KVM switch and the KVM switch transmits the EDID received from the first extender device to the second extender device.

15. The data processing system of claim 14, wherein the KVM switch is connected to the first extender device via a CAT 5 cable.

16. The data processing system of claim 14, wherein the KVM switch is connected to the second extender device via a CAT 5 cable.

17. The data processing system of claim 12, wherein the first and second extender devices are adapted to communicate with each other via a wired or wireless communication channel, and wherein the first extender device transmits the EDID to the second extender device directly via the communication channel.

18. The data processing system of claim 17, wherein the first and second extender devices are adapted to communicate with each other via a wired communication channel.

19. The data processing system of claim 17, wherein the first and second extender devices are adapted to communicate with each other via a wireless communication channel.

20. The data processing system of claim 12, wherein the first extender device is a keyboard video mouse (KVM) switch which includes one or more switching elements.
